(19) United States
(12) Patent Application Publication
(10) Pub. No.: US 2008/0046917 A1
(43) Pub. Date: Feb. 21, 2008

(54) Associating Advertisements with On-Demand Media Content

(75) Inventor: David L. de Heer, Woodside, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/461,254

(22) Filed: Jul. 31, 2006

(51) Int. Cl. H04N 7/10; H04N 7/025; G06F 3/00; G06F 13/00; H04N 5/445

(52) U.S. Cl. 725/32; 725/36; 725/42

(57) ABSTRACT

associating advertisements with on-demand media content is described. Advertisements are associated with media content that is available on-demand based on any number and combination of data analyses. Advertisements may be matched to media assets based on, for example, media quality, duration, time sensitivity of advertisements, positive keywords associations, and/or negative keyword associations. Auction-style bid values may also be associated with particular advertisements, such that an advertiser may be willing to pay a higher amount for the advertisement to be associated with a media asset having a particular keyword association or for the advertisement to have a more desirable placement within a play list.

### BACKGROUND

With the increasing availability and popularity of on-demand media content (e.g., video files, television programs, movies, music, still images, image slideshows, etc.), traditional methods of associating advertisements with media content may not be effective for the advertisers or economical for the media providers. For example, with traditional broadcast television, ad spots associated with a particular program are sold to advertisers based on predicted ratings (e.g., Nielsen ratings) for the program. However, when content is available strictly on-demand, viewership predictions become less reliable. Furthermore, there may be so much content available that it isn't economical for an advertiser to purchase advertisement placement with specific pieces of content. For example, if one million pieces of content were available on demand, selling advertising spots for each of the on-demand assets would not be reasonably feasible. Similarly, as an advertiser, selecting which of the million advertisements to advertise on would also be very difficult. One alternative may be to randomly associate ads with content, but this is undesirable because the ads may not match the content in terms of format, demographics, and/or message.

### SUMMARY

This Summary is provided to introduce a selection of concepts in a simplified form that are further described below in the Detailed Description. This Summary is not intended to identify key features or essential features of the claimed subject matter, not is it intended to be used as an aid in determining the scope of the claimed subject matter.

Techniques for associating advertisements with on-demand media content are described. Metadata associated with on-demand media assets is compared to metadata associated with available advertisements to determine which advertisements to associate with which media assets. Comparisons may be based on, for example, media quality, media duration, time sensitivity of advertisements, positive keyword associations, and/or negative keyword associations. Furthermore, auction-style bids may be associated with particular keywords and advertisements, indicating advertisers that are willing to pay a higher price for placement of their advertisements with media assets having similar associated keywords. Auction-style bids may also be used to indicate an advertiser's preference for location of an advertisement within a generated play list that may include a media asset and one or more advertisements.

### BRIEF DESCRIPTION OF THE DRAWINGS

FIG. 1 is a block diagram that illustrates an exemplary network environment in which advertisements can be associated with on-demand media content.

FIG. 2 is a block diagram that illustrates an exemplary data flow that may occur when on-demand media content is requested.

FIG. 3 is a block diagram that illustrates exemplary processing to associate advertisements with on-demand media content.

FIG. 4 is a block diagram that illustrates exemplary auction-based processing to associate advertisements with on-demand media content.

FIG. 5 is a flow diagram that illustrates an exemplary method for associating advertisements with on-demand media content.

FIG. 6 is a flow diagram that illustrates an exemplary method for responding to a request to access on-demand media content.

FIG. 7 is a block diagram that illustrates select components of an exemplary server computer system configured to associate advertisements with on-demand media content.

FIG. 8 is a block diagram that illustrates select components of a client device configured to receive advertisements in association with on-demand media content.

### DETAILED DESCRIPTION

The embodiments described below provide techniques for associating advertisements with on-demand media content.

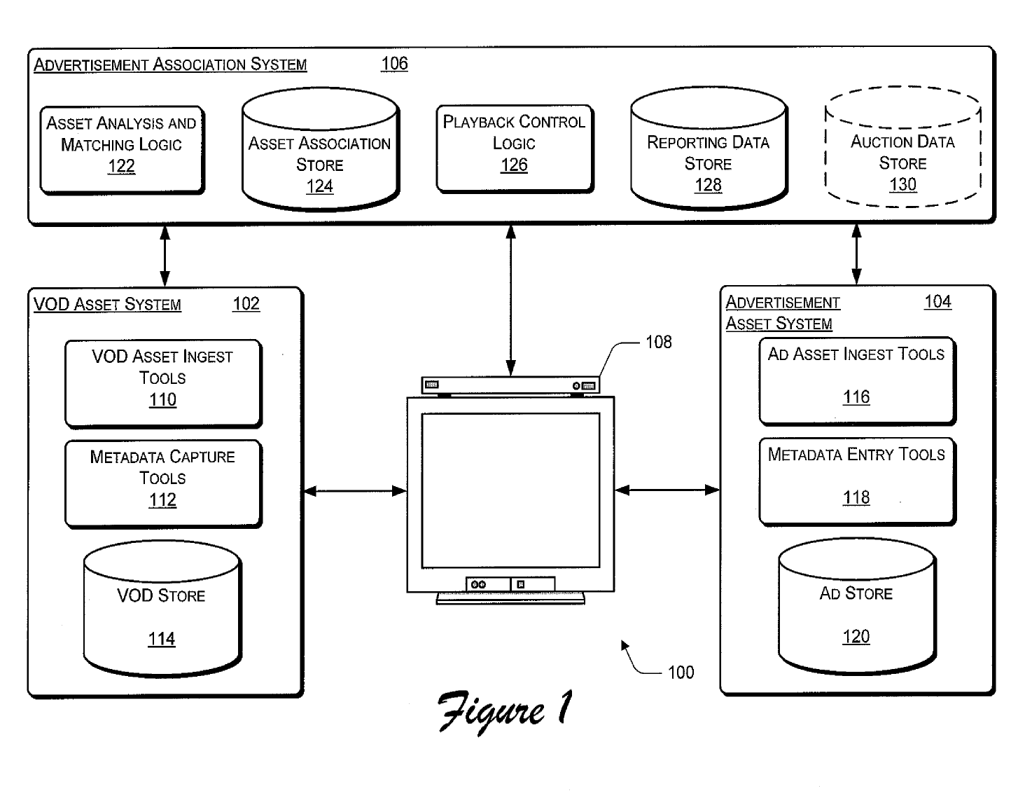

FIG. 1 illustrates an exemplary network environment 100 in which advertisements can be associated with on-demand media content. It is to be appreciated and understood that this exemplary network environment constitutes but one example of an environment in which the techniques described herein can be implemented. It is to be appreciated and understood that other environments can be utilized without departing from the spirit and scope of the claimed subject matter. For example, the embodiments described herein are described with respect to associating advertisements with video-on-demand, but it is recognized that advertisements may be associated with other types of on-demand media content in similar ways. For example, advertisements may be associated with video files, movies, television programs, music, video games, audio books, still images, image slideshows, music videos, and so on that may also be available on demand.

Exemplary network environment 100 includes video-on-demand (VOD) asset system 102, advertisement asset system 104, advertisement association system 106, and client device 108. Client device 108 represents any type of device capable of requesting and/or receiving on-demand media content. For example, in FIG. 1, client device 108 is illustrated as a television set-top box. Alternatively, client device 108 may be implemented as a personal computer, a laptop computer, a cell phone, a personal digital assistant, and/or any number of other types of personal computing devices. Client device 108 is configured to communicate with VOD asset system 102, advertisement asset system 104, and advertisement association system 106 via a network.

VOD asset system 102 receives VOD assets from content providers (not shown) and extracts metadata, which may include closed captioning information, associated with the VOD assets. Advertisement asset system 104 receives ads and metadata from advertisers (not shown). Advertisement association system 106 receives from client device 108, requests for on-demand VOD assets, dynamically matches advertisements with the requested VOD assets, directs the client device to play the requested VOD asset along with the matched advertisement(s), and generates reports and invoices for the advertisers.

Exemplary VOD asset system 102 includes VOD asset ingest tools 110, metadata capture tools 112, and VOD store 114. VOD asset ingest tools 110 provide mechanisms by which video content can be ingested from a content provider. Metadata capture tools 112 provide mechanisms by which metadata associated with the video content can be captured. VOD metadata may include, for example, resolution, duration, title, genre, rating, actor names, director, and so on. Such metadata may be included with the actual VOD asset when it is received from the content provider. Furthermore, metadata capture tools 112 may also include mechanisms by which keywords and/or phrases may be extracted from the VOD asset itself, for example, from closed captioning data associated with the video content (or, in the case of music, lyrics). VOD store 114 stores the VOD assets, associated metadata, and associated keyword indexes. In an exemplary implementation, the extracted keywords and/or phrases are indexed to enable efficient searching. For example, an indexed keyword list may include an alphabetical listing of words, each having an associated frequency value that indicates how many times that particular keyword was found in association with the VOD asset.

Exemplary advertisement asset system 104 includes ad asset ingest tools 1116, metadata entry tools 118, and ad store 120. Ad asset ingest tools 116 provide mechanisms by which advertisements can be ingested from advertisers. Metadata entry tools 118 provide mechanisms by which metadata associated with the advertisements can be entered. Such metadata may include, for example, ad resolution, ad duration, time sensitivity data, positive keywords, negative keywords, and so on. Keywords may include, for example, VOD titles, genres, ratings, actor names, director names, or other keywords.

Exemplary advertisement association system 106 includes asset analysis and matching logic 122, asset association store 124, playback control logic 126, reporting data store 128, and optionally, auction data store 130. Asset analysis and matching logic 122 is configured to associate advertisement assets with VOD assets based on a combination of resolution, duration, time-sensitivity, and keywords. The operator may choose to configure weights for the various matching criteria based on their business needs. In an exemplary implementation, asset association is performed periodically to reduce playback latency and minimize resource utilization. In an alternate implementation, asset association is performed dynamically when a request for a particular VOD asset is received.

When a request for a particular VOD asset is received, playback control logic 126 identifies one or more advertisements to be associated with the requested VOD asset, for example, based on data stored in asset association store 124. Playback control logic 126 generates and delivers to the client device, a play list that directs the client device to access the appropriate advertisements from ad store 120 and the requested VOD asset from VOD store 114.

Playback control logic 126 is also configured to receive a report from client device 108 confirming the playback of the delivered ads. This information is posted to reporting data store 128, and is used to periodically invoice advertisers based on the ads that have been played in association with requested VODs.

In an exemplary implementation, the operator and advertisers negotiate a base rate (e.g., cost per 1000 views) for ad impressions within the system. In such an implementation, the advertiser agrees to pay a specified amount each time a particular advertisement is reported as having been presented in association with a requested VOD asset. In addition, advertisement association system may include auction data store 130 that is implemented to support auction logic that may be implemented as part of asset analysis and matching logic 122. When auction logic is implemented, an advertiser can bid for ad placement priority with certain VOD titles based on title, genre, rating, keywords, or other supported metadata. Such an auction system may be implemented, for example, similarly to any number of existing web-based auction advertising systems.

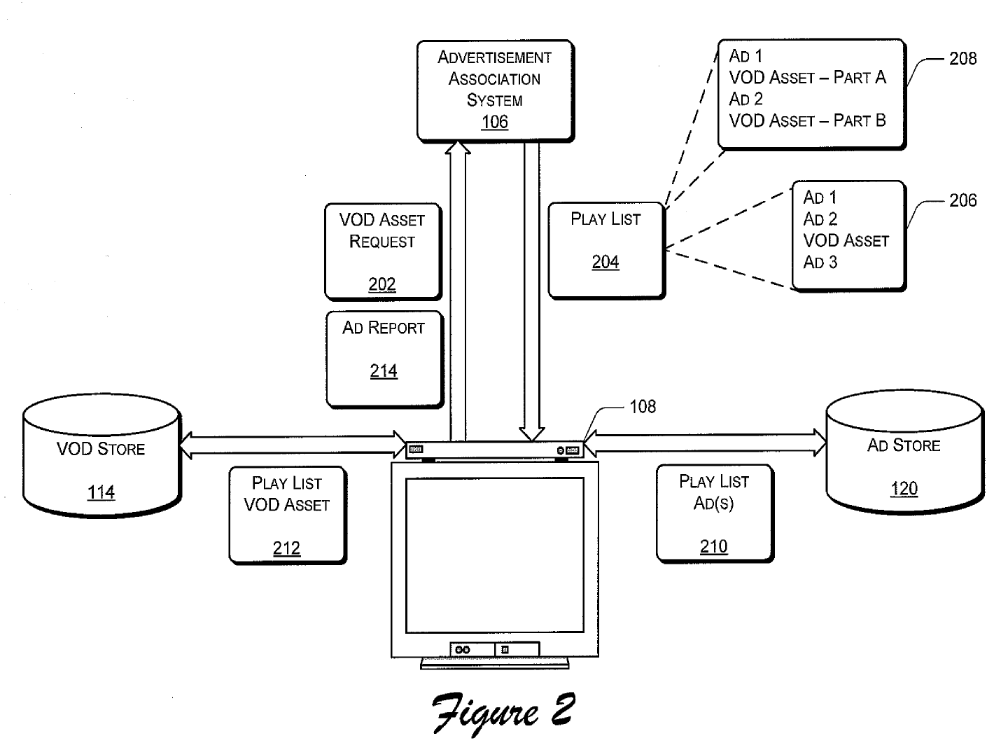

FIG. 2 illustrates an exemplary data flow that may occur when a user requests an on-demand video. Based on a user request, client device 108 transmits a VOD asset request 202 to advertisement association system 106. Based on the received request 202, a play list 204 is generated. Blocks 206 and 208 illustrate two exemplary play list formats that may be generated. Block 206 illustrates a play list that includes three advertisements and the requested VOD asset. In this example, two of the advertisements are played first, followed by the VOD asset, and finally, a third advertisement. Block 208 illustrates a play list that includes two advertisements and the requested VOD asset. In this example, the VOD asset is made up of two parts (part A and part B). The play list 208 indicates that a first advertisement will be played, followed by part A of the VOD asset, followed by a second advertisement, and finally, part B of the VOD asset. In an exemplary implementation, the media content and advertisements that are indicated in a play list may each be represented by a universal resource locator (URL) that will allow the client device to both locate and uniquely identify the items to be played. Play lists 206 and 208 are merely two examples of play lists that may be generated, and it is recognized that any combination and/or arrangement of media content and advertisements may be represented in a play list.

The generated play list 204 is returned to client device 108. Client device analyzes play list 204 and is accordingly directed to access advertisements 210 from ad store 120 and the VOD asset 212 from VOD store 114. In an exemplary implementation, as advertisements are played by client device 108, client device 108 generates an ad report 214 that is transmitted to advertisement association system 106. The data received in ad report 214 may be used to report to and/or invoice advertisers.

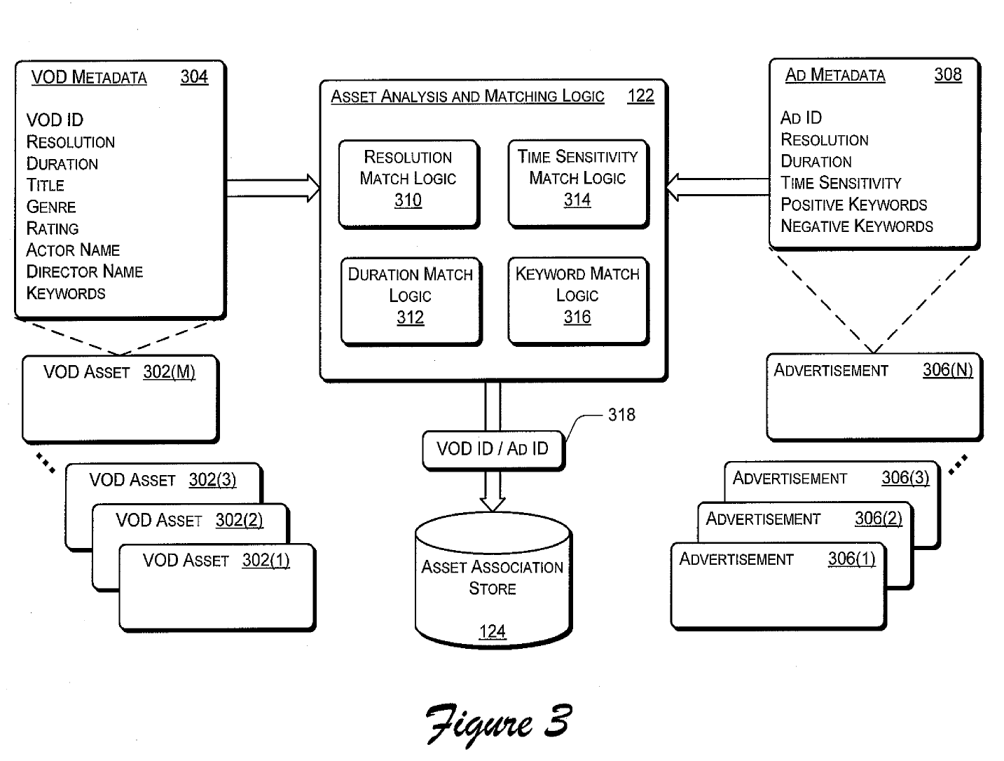

FIG. 3 illustrates exemplary processing that may be performed by asset analysis and matching logic 122. In an exemplary implementation, VOD assets 302(1), 302(2), 302(3), . . . , 302(M) are maintained by VOD store 114, shown in FIG. 1. VOD metadata 304 represents metadata that may be maintained by VOD store 114 in association with each respective VOD asset 302. As shown in FIG. 3, VOD metadata 304 may include, for example, a VOD ID that uniquely identifies the VOD asset, a resolution that indicates the video quality of the VOD asset, a duration that indicates a playing length of the VOD asset, a title, a genre, a rating, actor name(s), director name(s), and keywords associated with the VOD asset. As described above, metadata capture tools 112 may be used to extract the keywords directly from the VOD asset (e.g., from closed-captioning data) and the keywords may be maintained as an indexed list of keywords and their respective frequencies. In a system in which matching is performed dynamically, keywords entered by a user searching for a VOD asset may also be used as keywords associated with the VOD asset for purposes of matching advertisements to the VOD asset.

Similarly, advertisements 306(1), 306(2), 306(3), . . . , 306(N) are maintained by ad store 120, shown in FIG. 1. Ad metadata 308 represents metadata that may be maintained by ad store 120 in association with each respective advertisement 306. As shown in FIG. 3, ad metadata 308 may include, for example, an ad ID that uniquely identifies the advertisement, a resolution that indicates the video quality of the advertisement, a duration that indicates a playing length of the advertisement, time sensitivity data that indicates, for example, a time span during which the advertisement is appropriate. For example, an advertisement that describes an upcoming sale may have time sensitivity data that indicates that the advertisement is only appropriate for the two weeks prior to the date of the sale. Ad metadata 308 may also include positive keywords that indicate keywords with which the advertiser would like the advertisement to be associated, and negative keywords that indicate keywords with which the advertiser would not like the advertisement to be associated.

Asset analysis and matching logic 122 may include any number of logic modules that may be used in any combination to match available advertisements with available on-demand media content. In the exemplary implementation shown in FIG. 3, asset analysis and matching logic 122 includes resolution match logic module 310, duration match logic module 312, time-sensitivity match logic module 314, and keyword match logic module 316.

Asset analysis and matching logic 122 analyzes VOD metadata 304 and ad metadata 308 to identify a VOD ID/ad ID pair 318 to be maintained in asset association store 124. For example, for a given VOD asset, resolution match logic 310 analyzes the VOD metadata associated with the VOD asset to determine a resolution of the VOD asset. Resolution match logic 310 then analyzes the ad metadata 308 associated with the available advertisements to identify one or more advertisements having an associated resolution that can be appropriately matched with the resolution of the VOD asset. In one implementation, advertisements are matched to VOD assets having the same resolution as the advertisement. In an alternate implementation, advertisements are matched to a VOD assets if the resolution of the advertisement is not a lesser quality than the resolution of the VOD asset. It is further recognized that any type of comparison of resolution values associated with the advertisements and the VOD assets may be performed to determine whether or not to match a particular advertisement with a particular VOD asset. Furthermore, while resolution may be an appropriate indicator of quality associated with video-based ads and VOD assets, other quality indicators may be analyzed in a similar way for matching other types of ads to other types of on-demand media content. For example, a sound quality indicator may be analyzed when matching audio ads to audio-based on-demand media content.

Duration match logic 312 analyzes the VOD metadata associated with the VOD asset to determine a playing time of the VOD asset. Duration match logic 312 then analyzes the ad metadata 308 associated with the available advertisements to identify one or more advertisements having an associated duration that can be appropriately matched with the duration of the VOD asset. In one implementation, advertisements are matched to VOD assets if the duration of the advertisement is 10% or less than the duration of the VOD asset. It is recognized, however, that any type of comparison of durations associated with the advertisements and the VOD assets may be performed to determine whether or not to match a particular advertisement with a particular VOD asset.

Time sensitivity match logic 314 compares the current date and/or time with the ad metadata 308 associated with the available advertisements to identify one or more advertisements that are time-sensitive and can currently be appropriately matched with a VOD asset. For example, time sensitivity data associated with an advertisement may indicate a particular window of time (e.g., a few days) during which the advertisement is to be presented to users. Accordingly, if the current date/time is not within the specified time window, that advertisement will not be associated with a VOD asset.

Keyword match logic 316 analyzes the VOD metadata associated with the VOD asset to determine keywords associated with the VOD asset. As described above, the keywords associated with a VOD asset may include a title, a genre, a rating, actor names, director names, and/or other keywords, which may, for example, be extracted from closed captioning data associated with the VOD asset, and may also include keywords entered by a user when searching for the VOD asset. Keyword match logic 316 then analyzes the ad metadata 308 associated with the available advertisements to identify one or more advertisements having keywords that can be appropriately matched with the keywords of the VOD asset. In one implementation, advertisements are matched based on a match of positive keywords specified in ad metadata 308 with keywords specified in VOD metadata 304. In addition, particular advertisements may be dissociated from the VOD asset based on a match of negative keywords specified in ad metadata 308 with keywords specified in VOD metadata 304. It is also recognized that any type of comparison of keywords or other metadata associated with the advertisements and the VOD assets may be performed to determine whether or not to match a particular advertisement with a particular VOD asset.

Particular implementations may include any number and any combination of match logic modules (e.g., resolution match logic module 310, duration match logic module 312, time-sensitivity match logic module 314, and keyword match logic module 316). In an exemplary implementation, a plurality of advertisements may be identified for association with a particular VOD asset, and when the VOD asset is requested by a user, one or more of the identified advertisements are randomly selected to be presented along with the requested VOD asset. Furthermore, it is recognized that the results of each module may be weighted such that, for example, ads that match based on time sensitivity data may be given higher priority than ads that match based on resolution.

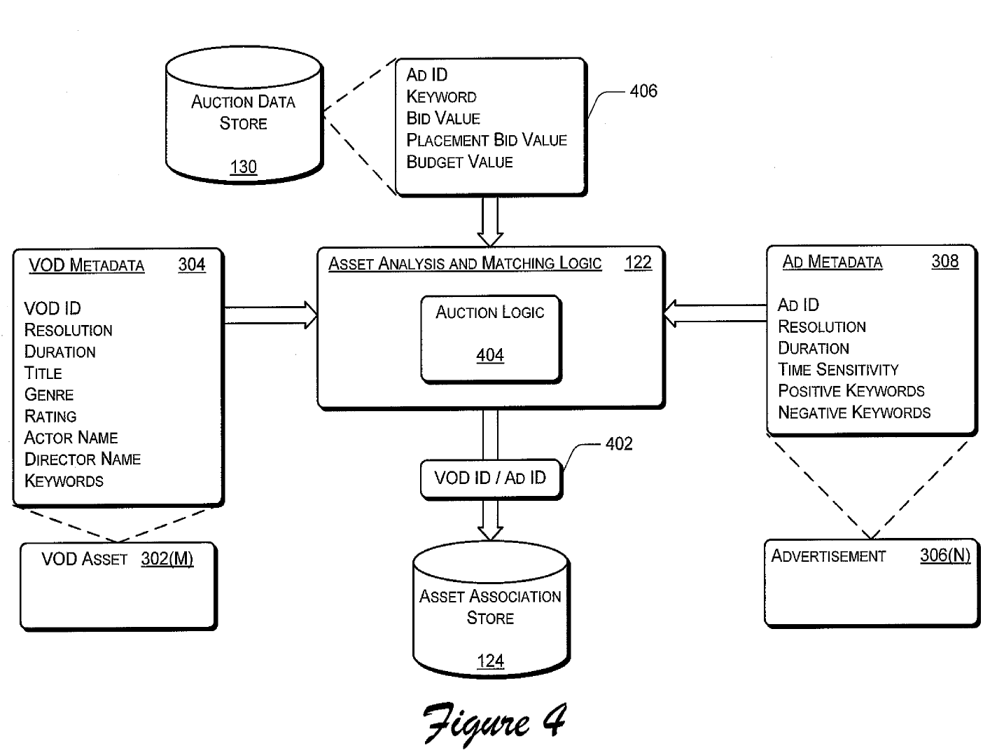

FIG. 4 illustrates exemplary auction-based processing that may be performed by asset analysis and matching logic 122. As shown and described above with reference to FIG. 3, VOD assets, represented by VOD asset 302(M), are maintained by VOD store 114, shown in FIG. 1, and VOD metadata 304 represents metadata that may be maintained by VOD store 114 in association with each respective VOD asset 302. Similarly, advertisements, represented by advertisement 306(N), are maintained by ad store 120, shown in FIG. 1, and ad metadata 308 represents metadata that may be maintained by ad store 120 in association with each respective advertisement 306.

Asset analysis and matching logic 122 analyzes VOD metadata 304 and ad metadata 308 to identify a VOD ID/ad ID pair 402 to be maintained in asset association store 124. In an exemplary implementation, asset analysis and matching logic 122 includes auction logic module 404, which may be used to implement an auction-style system for determining which advertisements are associated with which VOD assets. In such an implementation, auction data store 130 may maintain, for one or more advertisements, the ad ID, a keyword, a bid value, a placement bid value, and a budget value, as indicated by box 406. The keywords, bid values, and budget values are submitted by the advertisers.

In such an implementation, advertisers bid auction-style for association of advertisements with VOD assets with which particular keywords are associated. For example, an advertiser indicates a keyword associated with a particular advertisement and a bid value associated with that keyword, where the bid value indicates a maximum amount that the advertiser is willing to pay each time the advertisement is presented in association with a VOD asset based on that keyword. Along with keywords and bid values, advertisers typically also submit a budget value. After the budget value is reached (based on the price paid per requested VOD asset with which the advertisement is associated), the ad is no longer associated with VOD assets. In an exemplary implementation, the budget value may represent various types of budgets, such as, for example, a per-day budget, a per-week budget, a per-month budget, and so on.

In addition to bid values associated with keywords, advertisers may also submit bid values associated with placement within a play list, as indicated by the placement bid shown in box 406. For example, an advertiser may be willing to pay more for their advertisement to be played just prior to a requested VOD asset than for their advertisement to be played upon completion of the requested VOD asset.

In the implementation illustrated in FIG. 4, asset analysis and matching logic 122 may identify a plurality of ads that may be associated with a particular VOD asset (e.g., via resolution match logic 310, duration match logic 312, time sensitivity match logic 314, and/or keyword match logic 316). Auction logic 404 may then be utilized to determine which of the plurality of ads to associate with the VOD asset based on auction-style bid values maintained by auction data store 130.

As described above, matching advertisements to VOD assets may be performed periodically, or at the time a VOD asset is requested. In an exemplary implementation, a portion of the matching may be performed periodically, and additional matching may be performed dynamically, at the time a VOD asset is requested. For example, in an exemplary implementation, one or more of the match logic modules 310, 312, 314, and 316 shown in FIG. 3 may be implemented to perform periodic matching between advertisements and VOD assets such that several advertisements may be matched with a particular VOD asset. Subsequently, when the particular VOD asset is requested by a user, auction logic 404 may be implemented to dynamically select a particular one of the several advertisements that are matched with the particular VOD asset based, for example, on keywords and previously submitted bid values associated with the advertisements.

Methods for associating advertisements with on-demand media content may be described in the general context of computer executable instructions. Generally, computer executable instructions include routines, programs, objects, components, data structures, procedures, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

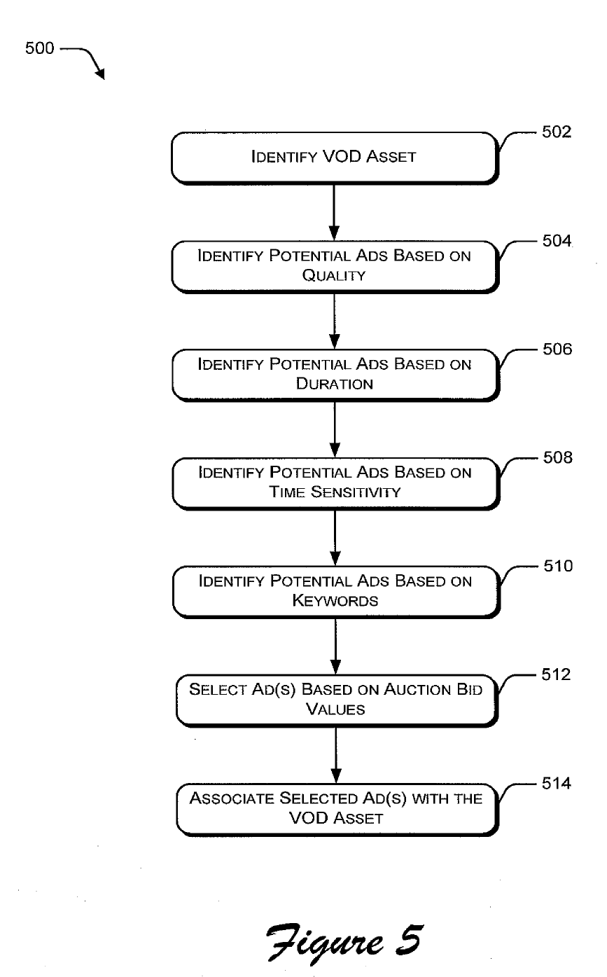

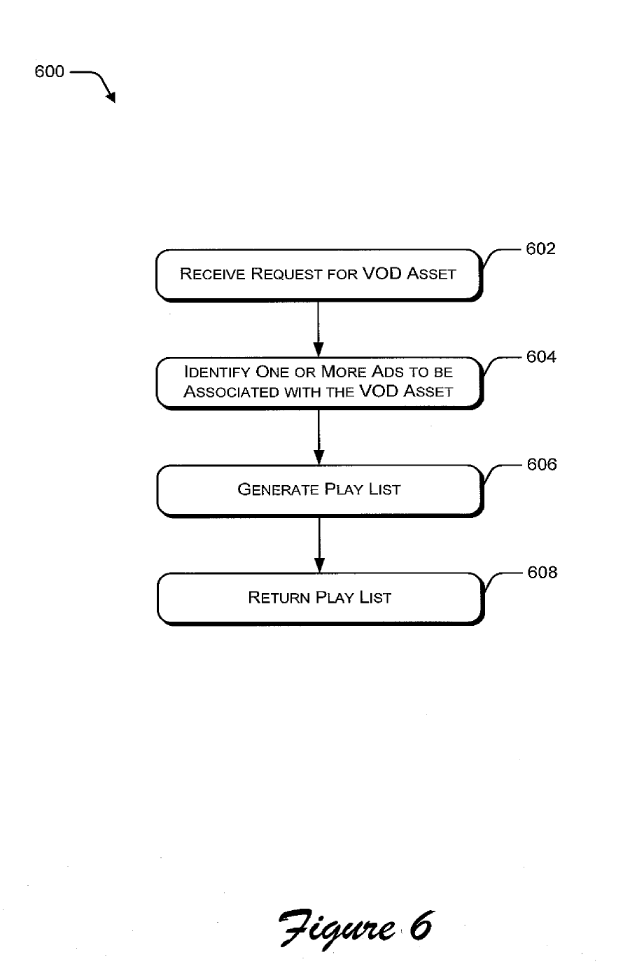

FIGS. 5 and 6 illustrate exemplary methods for associating advertisements with on-demand media content. FIGS. 5 and 6 are specific examples of associating advertisements with on-demand media content, and are not to be construed as limitations. The order in which the method blocks are described is not intended to be construed as a limitation, and any number of the described method blocks can be combined in any order to implement the methods. Furthermore, the methods can be implemented in any suitable hardware, software, firmware, or combination thereof.

FIG. 5 illustrates an exemplary method 500 for associating advertisements with on-demand media content. At block 502, a particular VOD asset is identified. For example, a VOD asset maintained in VOD store 114 is selected. In one implementation, advertisements are associated with VOD assets periodically, in which case, a VOD asset is automatically selected from VOD store 114 as part of the periodic processing. In an alternate implementation, advertisements are associated with a particular VOD asset dynamically, when a user requests the VOD asset.

At block 504, potential ads are identified based on quality. For example, resolution match logic 310 performs a comparison between a quality (e.g., resolution) associated with the VOD asset and a quality (e.g., resolution) associated with the available advertisements. Available advertisements that may be appropriately associated with the VOD asset, based on quality, are identified.

At block 506, potential ads are identified based on duration. For example, duration match logic 312 performs a comparison between a duration associated with the VOD asset and a duration associated with the available advertisements. Available advertisements that may be appropriately associated with the VOD asset, based on duration, are identified.

At block 508, potential ads are identified based on time sensitivity. For example, time sensitivity match logic 314 performs a comparison between a current date/time and a time window associated with the available advertisements. Available advertisements that may be appropriately associated with the VOD asset, based on time sensitivity, are identified.

At block 510, potential ads are identified based on keywords. For example, keyword match logic 316 performs a comparison between keywords associated with the VOD asset and positive and negative keywords associated with the available advertisements. In an exemplary implementation, advertisements having negative keywords that match keywords associated with the VOD asset are not identified as potential advertisements, while advertisements having positive keywords that match keywords associated with the VOD asset may be identified as potential advertisements.

At block 512, one or more advertisements to be associated with the VOD asset are selected based on auction bid values. For example, auction logic 404 compares bid values associated with the advertisements that have been identified as potential advertisements, and selects those with the most favorable bid values for which the budget value has not yet been met.

At block 514, the selected advertisement(s) are associated with the VOD asset. For example, a VOD ID/ad ID pair (218 or 302) is added to asset association store 124.

In an exemplary implementation, when multiple processes are used to identify potential advertisements, each process can be thought of as a filter that further filters the results provided by the previous process. For example, if all of the processes described with reference to FIG. 5 are implemented, a first process filters the available advertisements based on quality. A second process receives as input, the advertisements that passed the first filter, and outputs advertisements that are appropriate based on quality and duration. A third process receives as input, the advertisements that passed the second filter, and outputs advertisements that are appropriate based on quality, duration, and time sensitivity. A fourth process receives as input, the advertisements that passed the third filter, and outputs advertisements that are appropriate based on quality, duration, time sensitivity, and keywords. Finally, auction bid values are utilized to further narrow the potential advertisements, if necessary.

In an alternate implementation, the various logic modules that are utilized to identify advertisements to associate with a VOD asset are weighted such that the results from the analysis performed by one logic module may be considered more important that the results from the analysis performed by another logic module. In such an implementation, each module may analyze the available advertisements independently, and then, according to the weights associated with each module, the results from each of the modules are pooled together and analyzed to select one or more advertisements to associate with a particular VOD asset.

FIG. 6 illustrates an exemplary method 600 for responding to a request for a VOD asset. At block 602, a request for a particular VOD asset is received. For example, playback control logic 126 receives a VOD asset request 202 from client device 108.

At block 604, one or more advertisements to be associated with the requested VOD asset are identified. For example, playback control logic 126 queries asset association store 124 to identify one or more advertisements that are associated with the requested VOD asset.

At block 606, a play list is generated. For example, playback control logic 126 creates a list that includes instructions for accessing the requested VOD asset and any associated advertisements, in a particular order.

At block 608, the play list is returned. For example, playback control logic 126 transmits the play list to client device 108. Client device 108 is then directed, according to the play list, to access the requested VOD asset and the associated advertisements.

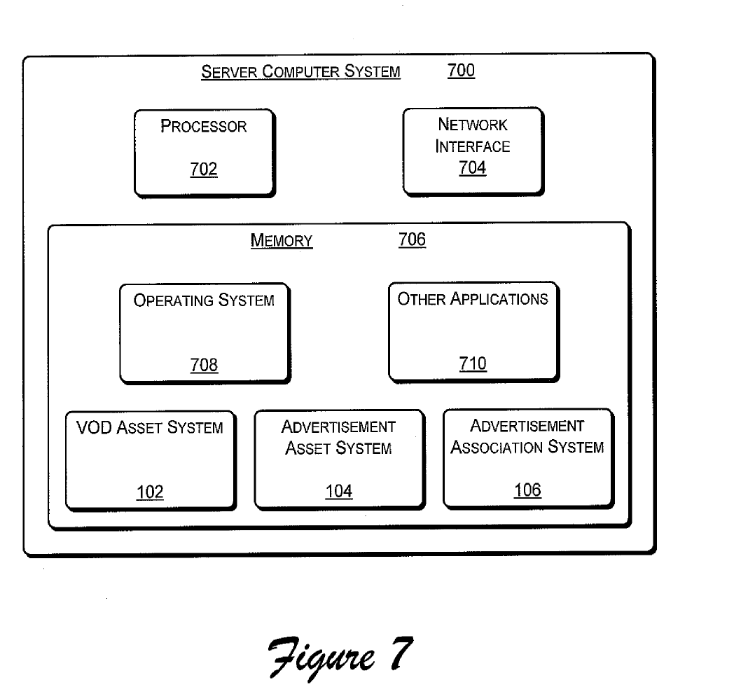

FIG. 7 is a block diagram that illustrates select components of an exemplary server computer system configured to associate advertisements with on-demand media content. Exemplary server computer system 700 includes one or more processors 702, a network interface 704, and memory 706. Operating system 708 and other applications 710 are stored in memory 706 and executed by processor 702. VOD asset system 102, advertisement asset system 104, and advertisement association system 106 are also stored in memory 706 and executed by processor 702. Although shown in memory on the same server computer system 700, it is recognized that VOD asset system 102, advertisement asset system 104, and/or advertisement association system 106 may each be implemented on an independent server computer system, and furthermore, may each be implemented across multiple independent server computer systems.

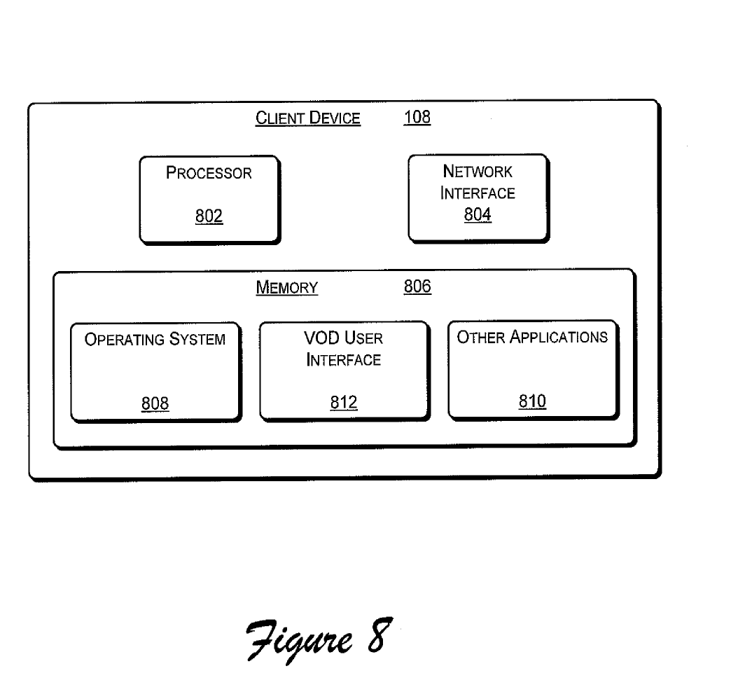

FIG. 8 is a block diagram that illustrates select components of a client device configured to receive advertisements in association with on-demand media content. Exemplary client device 108 includes one or more processors 802, a network interface 804, and memory 806. Operating system 808 and other applications 810 are stored in memory 806 and executed by processor 802. VOD user interface 812 is also stored in memory 806 and executed by processor 802. VOD user interface 812 provides a mechanism by which a user can select a VOD asset, which will typically be delivered with associated advertisements.

Although embodiments of associating advertisements with on-demand media content have been described in language specific to structural features and/or methods, it is to be understood that the subject of the appended claims is not necessarily limited to the specific features or methods described. Rather, the specific features and methods are disclosed as exemplary implementations of associating advertisements with on-demand media content.

1. A method, implemented at least in part by a computer, comprising dynamically associating an advertisement with an on-demand media entity based, at least in part, on a comparison of a duration associated with the advertisement and a duration associated with the on-demand media entity.

2. The method as recited in claim 1, wherein the on-demand media entity comprises at least one of a video file, a music file, a movie, a television program, a still image, an image slideshow, a collection of images, a collection of videos, a music video, a song, an album, a collection of songs, a video game, or an audio book.

3. The method as recited in claim 1, further comprising, dynamically associating the advertisement with the on-demand media entity based, at least in part, on a comparison of a media quality associated with the advertisement and a media quality associated with the on-demand media entity.

4. The method as recited in claim 3, wherein the media quality comprises a video resolution.

5. The method as recited in claim 3, wherein the media quality comprises an audio quality.

6. The method as recited in claim 1, further comprising, dynamically associating the advertisement with the on-demand media entity based, at least in part, on a comparison of a current date and time and time sensitivity data associated with the advertisement.

7. The method as recited in claim 1, further comprising, dynamically associating the advertisement with the on-demand media entity based, at least in part, on an auction bid associated with the advertisement, wherein the auction bid indicates a maximum amount an advertiser is willing to pay to have the advertisement associated with the on-demand media entity.

8. The method as recited in claim 1, further comprising, dynamically associating the advertisement with the on-demand media entity based, at least in part on a comparison of keywords associated with the advertisement and keywords associated with the on-demand media entity.

9. The method as recited in claim 8, where the keywords associated with the on-demand media entity comprise keywords extracted from closed captioning data associated with the on-demand media entity.

10. The method as recited in claim 8, where the keywords associated with the on-demand media entity comprise at least one of a title, an actor name, a rating, or song lyrics.

11. The method as recited in claim 8, where the keywords associated with the advertisement indicate keywords that may be associated with an on-demand media entity with which the advertisement may be associated.

12. The method as recited in claim 8, where the keywords associated with the advertisement indicate keywords that may be associated with an on-demand media entity with which the advertisement is not to be associated.

13. The method as recited in claim 1, further comprising:
receiving a user-request for the on-demand media entity; and
in response to the user-request, returning a play list that includes a representation of the on-demand media entity and the advertisement, such that when the on-demand media entity is played, the advertisement is also played.

14. The method as recited in claim 13, wherein, placement of the advertisement in relation to the on-demand media entity or other advertisements within the play list is based, at least in part, on a bid value associated with the advertisement.

15. A system comprising:
means for maintaining a plurality of media assets that are available on-demand;
means for maintaining a plurality of advertisements that may be associated with the media assets; and
means for dynamically associating a particular one of the plurality of advertisements with a particular one of the plurality of media assets based at least in part on a comparison of a media quality associated with the particular one of the plurality of advertisements and a media quality associated with the particular one of the plurality of media assets.

16. The system as recited in claim 15, further comprising means for dynamically associating a particular one of the plurality of advertisements with a particular one of the plurality of media assets based at least in part on a comparison of a duration associated with the particular one of the plurality of advertisements and a duration associated with the particular one of the plurality of media assets.

17. The system as recited in claim 15, further comprising means for dynamically associating a particular one of the plurality of advertisements with a particular one of the plurality of media assets based at least in part on a comparison of a keyword associated with the particular one of the plurality of advertisements and a keyword associated with the particular one of the plurality of media assets.

18. The system as recited in claim 15, further comprising:
means for maintaining bid values associated with the advertisements; and
means for dynamically associating a particular one of the plurality of advertisements with a particular one of the plurality of media assets based at least in part on a bid value associated with the particular one of the plurality of advertisements.

19. One or more computer-readable media comprising computer-executable instruction that, when executed, cause a computing system to:
associate keywords with individual ones of a plurality of on-demand media assets;
associate keywords and respective bid values with individual ones of a plurality of advertisements; and
dynamically associate a particular one of the plurality of advertisements with a particular one of the plurality of on-demand media assets based, at least in part, on:
a match between a keyword associated with the on-demand media asset and a keyword associated with the advertisement; and
an analysis of the bid value associated with the keyword and the advertisement.

20. The one or more computer-readable media as recited in claim 19, further comprising computer-executable instruction that, when executed, cause the computing system to:
associate negative keywords with individual ones of the plurality of advertisements; and
disassociate a particular one of the plurality of advertisements from a particular one of the plurality of on-demand media assets based, at least in part, on a match between a keyword associated with the on-demand media asset and a negative keyword associated with the advertisement.
